(19) United States
(12) Patent Application Publication
(10) Pub. No.: US 2009/0005013 A1
(43) Pub. Date: Jan. 1, 2009

(54) SYSTEM AND METHOD FOR DOWNLOADING CELL PHONE VOICEMAILS TO A USER'S CELL PHONE

(76) Inventor: Douglas B. Davis, Raleigh, NC (US)

Correspondence Address: HOFFMAN WARNICK LLC, 75 STATE ST, 14TH FLOOR, ALBANY, NY, 12207, US

(21) Appl. No.: 11/769,079

(22) Filed: Jun. 27, 2007

(51) Int. Cl. H04M 11/10

(52) U.S. Cl. 455/413

(57) ABSTRACT

A system and method allows a user to be able to automatically download cell phone voicemail messages to his cell phone. While the cell user is in his network, the cell phone, which is in constant contact with the cell server, requests for a download of voicemail messages, if any. The messages which have been downloaded are stored in the cell phone for processing at later time. The user is no longer constrained by network coverage when he wants to listen to new (or old) messages. All it requires is that he is in his network at some point long enough for the phone to download the new messages. Also, this saves the user money since it doesn't require him to use his cell minutes to check messages.

### FIELD OF THE INVENTION

The present invention relates generally to cell phones and voicemail messages and, more specifically, to a system and method for automatically downloading voicemail messages to a user's cell phone and stored in the cell phone for later disconnected access.

### BACKGROUND OF THE INVENTION

Currently when a cell phone user wishes to listen to their voicemail it requires that the cell phone user be in their network and have a good enough signal to be able to hear it clearly. For instance, FIG. 1 illustrates a basic cellular phone system where User A 102 wishes to speak with User B 102b over the cell network 104 using cell phones 108a, 108b. (More information on cell networks may be found here: http://cellularnetwork.oxitown.com/.) Cell network 104 has one or more Cell Servers 106 which has, as most if not all servers, a Network I/O 112, an Internal Bus 116, a CPU 114 but in addition has Voicemail Box Databases 118 which hold voicemail boxes of various subscribers to the network, such as User B's Voicemail Box 118, for holding voicemails for the users. In the present example, User A 102 has a Cell Connection 111. A cell connection is where the user's cell phone is in constant radio contact with a cell site. Sometimes, of course, the cell connection is temporarily lost, such as during a cell handoff or where the user is moving out of range of the cell site. Alternatively, the user's cell phone may be turned off. Naturally, in order to make a cell call, the user must have a cell connection.

In the present example, User B 102b is not available—such as his phone being turned off or his being out of range, for example. When this happens, Cell Server 106 automatically puts User A's call into User B's Voicemail Box 113 which is merely a voice response unit offering to record a voicemail message (User A's Voicemail Message 110) for later pickup by User B. Some time later, when User B 102b has a Cell Connection 115, he may check his voicemail box for messages. Most cell services will provide a notification to the user that a new message exists. In order to access the voicemail message, User B 102b must manually request (User B Manual Voicemail Request 117) his voicemail messages which many times is done by the user dialing his own cell number, inputting his password and choosing to listen to the existing voicemail message. Cell Server 106 provides access to the User A Voicemail 113 so that User B may listen to it.

However, if User B cannot, for a period of time, obtain a cell connection, such as if he is on an airplane trip, or does not have the time to manually request to listen to the voicemail, he cannot listen to the voicemails. This is shown in FIG. 2 where if the Cell Connection 115 is lost, even if User B makes the manual request (User B Manual Request 117), because there is no cell connection, he cannot get access to his voicemail.

Additionally, if User B is in a cell with a bad connection, the voice mail will not be received with high fidelity and User B may have to listen to the message numerous times to understand it. Also, if the user receives a message for which he needs to write down some information, such as a phone number, he may not have a pad and pen and will have to go through the whole process again sometime later. That leaves the chance that he may forget to call.

There presently is a need for a system and method for automatically downloading voicemail messages to a user's cell phone and for storing the messages on the cell phone for later processing. There is also a need for the voicemail messages to be downloaded in a format for providing high fidelity for audio, such as audio encoding format MP3.

### BRIEF SUMMARY OF THE INVENTION

The present invention is a system and method for automatically downloading voicemail messages to a user's cell phone and for storing the messages on the cell phone for later processing. In an alternate mode, the system and method download the messages in a format for providing high fidelity audio, such as MP3.

Using the system and method of the present invention, the user is able to automatically download cell phone voicemail messages to his cell phone. While the cell user is in his network, the cell phone, which is in constant contact with the cell server, requests for a download of voicemail messages, if any. The messages which have been downloaded are stored in the cell phone for processing at later time. Because a lot of cell phones today have the ability to download, store and play data representing audio (such as music in the form of MP3), the present invention allows a user to use that same feature but for voicemail. The user can then listen to his messages with the clarity of the music his phone can play. The user can also do this even when he is totally disconnected from his network (e.g., on a plane). He is no longer constrained by network coverage when he wants to listen to new (or old) messages. All it requires is that he is in his network at some point long enough for the phone to download the new messages. Also, this saves the user money since it doesn't require him to use his cell minutes to check messages.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 depicts a basic cellular phone system showing basic phone mail processing of the prior art.

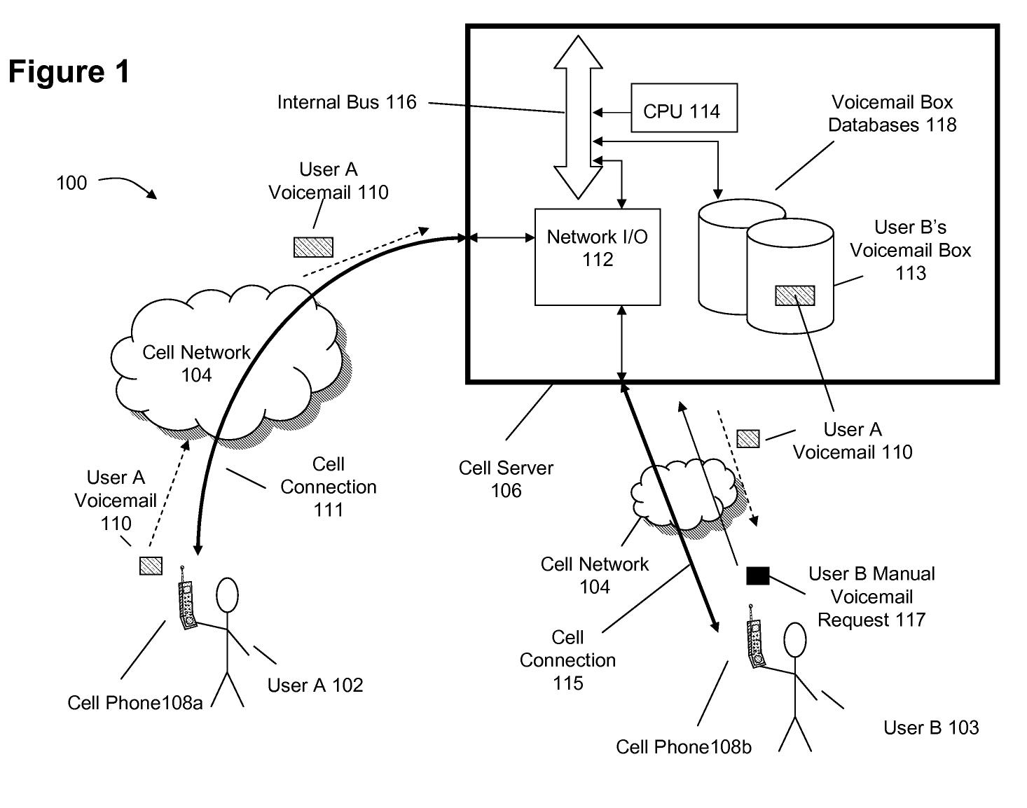

FIG. 2 shows the same cellular phone system showing the problems of phone mail processing of the prior art

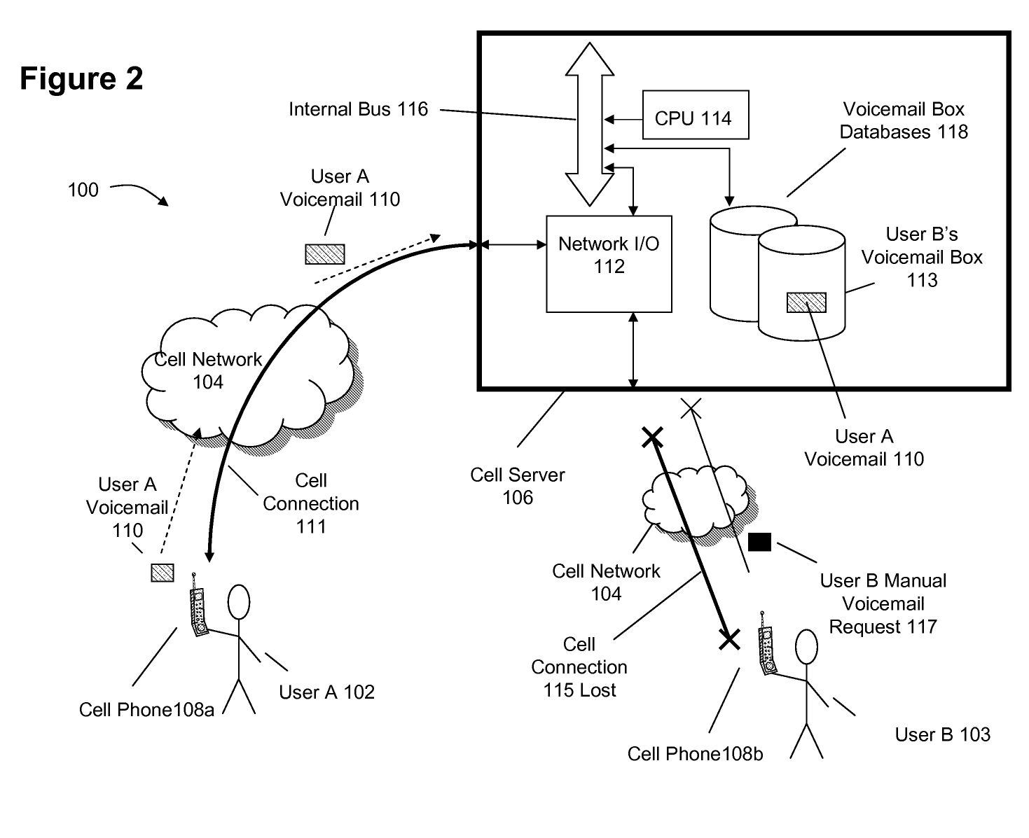

FIG. 3 illustrates the system and method of the present invention.

FIG. 4 illustrates the method for automatically downloading voicemail messages to a user's cell phone and stored in the cell phone for later disconnected access.

FIG. 5 illustrates the method illustrating the offline processing (such as listening, saving, etc.) of previously stored voicemail messages.

The drawings are intended to depict only typical aspects of the invention, and therefore should not be considered as limiting the scope of the invention. In the drawings, like numbering represent like elements between the drawings.

### DETAILED DESCRIPTION OF THE INVENTION

The present invention provides the system and method for automatically downloading voicemail messages to a user's cell phone and stored in the cell phone for later disconnected access. In an alternative embodiment, the messages are stored on the user's cell phone in a high audio fidelity format, such as MP3.

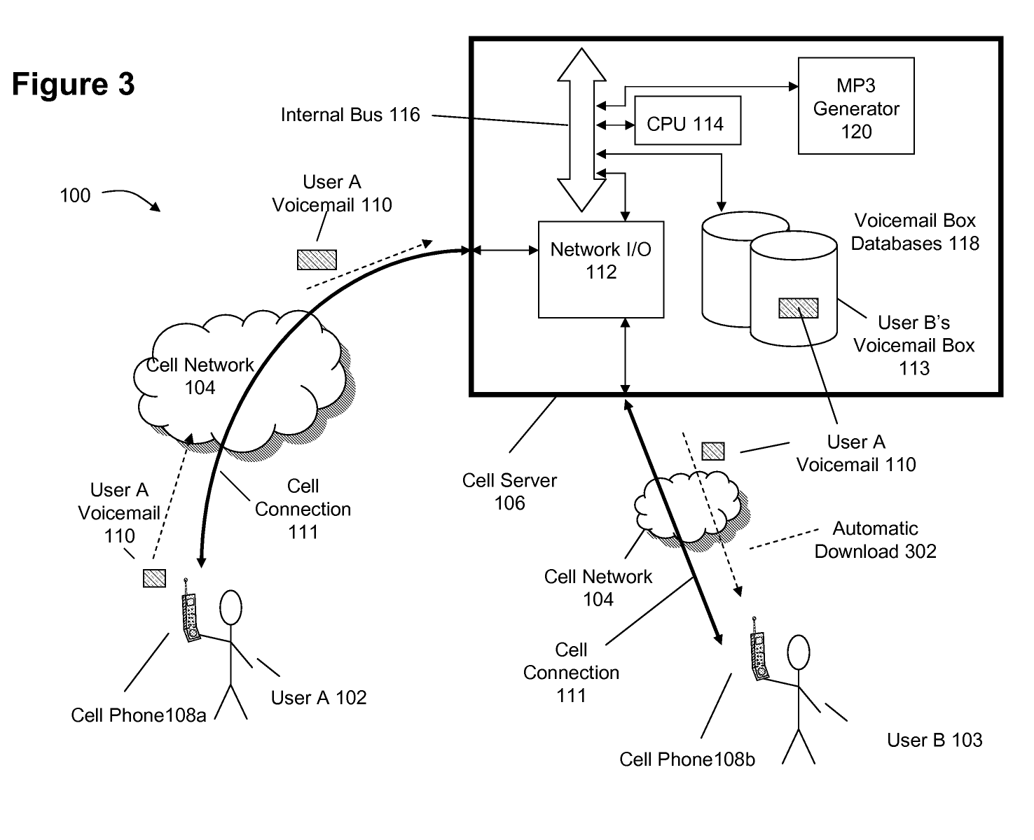

FIG. 3 depicts the system and method of the present invention. As was discussed previously, User A 102 leaves User A Voicemail 113 in User B's Voicemail Box 113. User B's Cell Phone 108b is in contact with Cell Server 106 from time to time as the Cell Connection 111 may drop in and out. Each time Cell Connection 111 provides a signal to Cell Phone 108b and there is communication between Cell Phone 108b and Cell Server 106, Cell Phone 108b requests for voicemail messages, if any, in User B's Voicemail Box 113. If there is one or more voicemail messages, such as User A Voicemail Message 110, the messages are downloaded to the cell phone and stored in the cell phone memory. Cell Server 106 may have an MP3 Generator 120 so that the voicemail messages are downloaded in MP3 format. MP3 is a popular audio encoding format. It uses a lossy compression algorithm that is designed to greatly reduce the amount of data required to represent the audio recording, yet still sound like a faithful reproduction of the original uncompressed audio to most listeners. Because a lot of cell phones today have the ability to download, store and play MP3s, the present invention allows a user to use that same feature but for voicemail. The user can then listen to his messages with the clarity of the music his phone can play. The user can also do this even when he is totally disconnected from his network (e.g., on a plane).

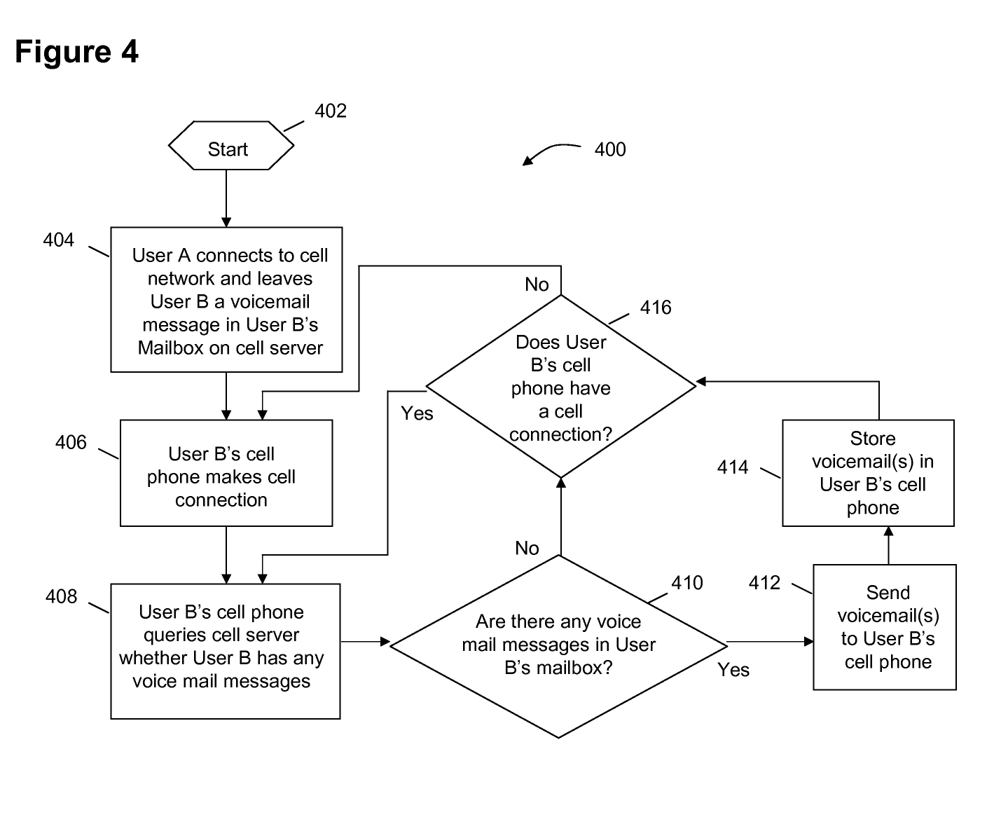

FIG. 4 illustrates the method 400 for automatically downloading voicemail messages to a user's cell phone and stored in the cell phone for later disconnected access. Method 400 starts at step 402 and continues to step 404 where User A connects or previously has a connection to the cell network and leaves a voice mail message for User B in User B's voicemail message mailbox. At step 406, User B's cell phone connects or previously has a connection to the cell network. At step 408, User B's cell phone queries the cell server as to whether User B's mailbox contains any voicemail messages for User B. At step 410, cell server determines whether User B's mailbox contains any voicemail messages for User B. If so, at step 412, cell server sends the voicemail messages for User B to User B's cell phone. At step 414, User B's cell phone stores the voicemail messages for User B and moves to step 416. If not, at step 416, User B's cell phone determines whether it has a cell connection. If not, the method moves to step 406 as previously discussed. If so, the method moves to step 408 as previously discussed.

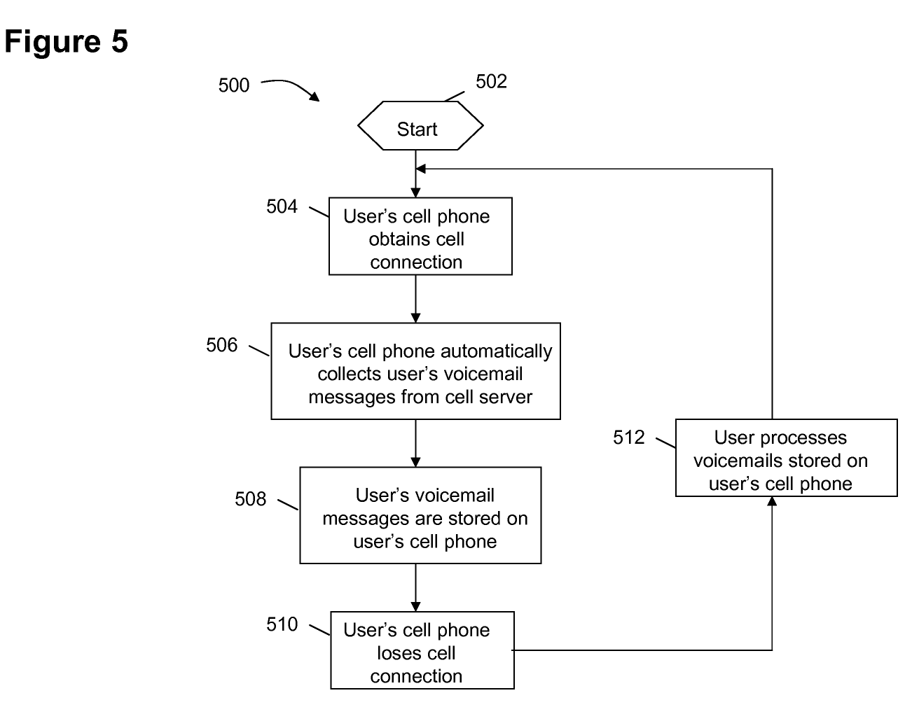

FIG. 5 illustrates the method 500 illustrating the offline processing (such as listening, saving, etc.) of previously stored voicemail messages. The method 500 starts at 502 and continues to step 504 where user's cell phone obtains a cell connection. At step 506, user's cell phone automatically collects user's voicemail messages from the cell server and, at step 508, user's voicemail messages are stored on the user's cell phone as previously discussed with respect to FIG. 4. At step 510, user's cell phone obtains a cell connection. At step 512, user processes the user's voicemail messages which were previously stored on the user's cell phone and returns to step 504.

In an alternative embodiment, cell server provides the user's voicemail messages in MP3 format so that the user can listen to his messages with the clarity of the music his phone can play. The user can also do this even when he is totally disconnected from his network (e.g., on a plane). He is no longer constrained by network coverage when he wants to listen to new (or old) messages. All it requires is that he is in his network at some point long enough for the phone to download the new messages. This also solves the problem where a user is listening to a voicemail in an area where the cell connection is not strong and the voice mail message has low clarity. By utilizing the MP3 format, the voicemail is very clear regardless of the cell connection strength.

It should be noted that this invention is not limited to voicemails as today's cell phones now offer text messaging, instant messaging, video services, photo services, music services and the like. That is to say, User A may send to User B a video, such as in MPEG form, which is stored on the cell server for automatic download to User B's cell in a similar manner as been discussed above. The same holds for photos, music, etc.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A method for automatic download of voicemails for later access, the method comprising the steps of:
a. receiving, from a first user having a cell phone, a voicemail message for a second user at a cell server;
b. storing the voicemail message in a second user's voicemail box in the cell server;
c. sending, from the second user's cell phone without any prompting by the second user, a request to the cell server for any voicemail messages in a second user's voicemail box;
d. sending, from the cell server, the voicemail message to the second user's cell phone;
e. receiving the voicemail message at the second user's cell phone; and
f. storing the voicemail message at the second user's cell phone.

2. The method of claim 1 further comprising the step g, after step f, of, determining, by the second user's cell phone without any prompting by the second user, whether it has cell network access and, if so, returning to step c or, if not, returning to step g.

3. The method of claim 1 further comprising the step, prior to step d, of, at the cell server, converting the voicemail message into an audio encoding format.

4. The method of claim 3 wherein the audio encoding format is the MP3 format.

5. A method, in a cell phone associated with a cell phone user, for automatic download, over a cell network, of voicemails, for later access, from a cell server having one or more voicemail boxes, at least one voicemail box associated with a cell account of the cell phone user, the method comprising the steps of:
a. obtaining access to the cell network;
b. requesting, from the cell server, any voicemails in the voicemail box associated with a cell account of the cell phone user, without any prompting by the cell phone user;
c. receiving, at the cell phone from the cell server, voicemails from the voicemail box associated with the cell account; and
d. storing the voicemails from the voicemail box associated with the cell account in the cell phone.

6. The method of claim 5 further comprising a step e, after step d, of determining, by the cell phone, without any prompting by the cell phone user, whether the cell phone has access to the cell network and, if so, going to step b or, if not, repeating step e.

7. The method of step 5 further comprising the step of allowing the cell phone user access to any stored voicemail messages whether or not the cell phone has cell network access.

8. The method of claim 5 wherein in step d, the voicemails are stored in an audio encoding format.

9. The method of claim 8 wherein the audio encoding format is the MP3 format.

10. A computer program product in a computer readable medium for operating in a system comprising a network I/O, a CPU, and one or more databases, for implementing a method, in a cell phone associated with a cell phone user, for automatic download, over a cell network, of voicemails, for later access, from a cell server having one or more voicemail boxes, at least one voicemail box associated with a cell account of the cell phone user, the method comprising the steps of:
a. obtaining access to the cell network;
b. requesting, from the cell server, any voicemails in the voicemail box associated with a cell account of the cell phone user, without any prompting by the cell phone user;
c. receiving, at the cell phone from the cell server, voicemails from the voicemail box associated with the cell account; and
d. storing the voicemails from the voicemail box associated with the cell account in the cell phone.

11. The computer program product of claim 10 wherein the method further comprises step e, after step d, of determining, by the cell phone, without any prompting by the cell phone user, whether the cell phone has access to the cell network and, if so, going to step b or, if not, repeating step e.

12. The computer program product of claim 10 wherein the method further comprises the step of allowing the cell phone user access to any stored voicemail messages whether or not the cell phone has cell network access.

13. The computer program product of claim 10 wherein in the method, in step d, the voicemails are stored in an audio encoding format.

14. The computer program product of claim 13 wherein the audio encoding format is the MP3 format.

15. A cell phone associated with a cell phone user, for automatic downloading, over a cell network, voicemails, and storing for later access, from a cell server having one or more voicemail boxes, at least one voicemail box associated with a cell account of the cell phone user, the cell phone implementing a method comprising the steps of:
a. obtaining access to the cell network;
b. requesting, from the cell server, any voicemails in the voicemail box associated with a cell account of the cell phone user, without any prompting by the cell phone user;
c. receiving, at the cell phone from the cell server, voicemails from the voicemail box associated with the cell account; and
d. storing the voicemails from the voicemail box associated with the cell account in the cell phone.

16. The cell phone of claim 15 wherein the method further comprises step e, after step d, of determining, by the cell phone, without any prompting by the cell phone user, whether the cell phone has access to the cell network and, if so, going to step b or, if not, repeating step e.

17. The cell phone of step 15 wherein the method further comprises the step of allowing the cell phone user access to any stored voicemail messages whether or not the cell phone has cell network access.

18. The cell phone of claim 15 wherein in step d of the method, the voicemails are stored in an audio encoding format.

19. The cell phone of claim 18 wherein the audio encoding format is the MP3 format.
